(19) United States
(12) Patent Application Publication
(10) Pub. No.: US 2024/0352344 A1
(43) Pub. Date: Oct. 24, 2024

(54) PROCESS FOR PRODUCING KEROSENE AND DIESEL FROM RENEWABLE SOURCES

(71) Applicant: SHELL USA, INC., HOUSTON, TX (US)

(72) Inventors: Pui Yiu Ben CHAN, Houston, TX (US); Venkatesh THYAGARAJAN, Amsterdam (NL); Edmundo Steven VAN DOESBURG, Amsterdam (NL); Rubin Keith WHITT, Houston, TX (US); Artur YARULIN, Amsterdam (NL)

(21) Appl. No.: 18/685,286

(22) PCT Filed: Sep. 14, 2022
(86) PCT No.: PCT/US2022/043418

§ 371 Date: Feb. 21, 2024

Related U.S. Application Data
(60) Provisional application No. 63/245,009, filed on Sep. 16, 2021.

(30) Foreign Application Priority Data
Sep. 28, 2021 (EP) 21199563.4

(51) Int. Cl. C10G 49/22

(52) U.S. Cl. CPC C10G 49/22; C10G 2300/1003; C10G 2300/1011; C10G 2300/4081

(57) ABSTRACT

A process for improving yield of kerosene from a renewable feedstock involves directing a hydroprocessed liquid stream to a lead stripper to separate a lead stripper bottoms stream and a lead stripper overhead stream comprising naphtha, lower and higher boiling point range hydrocarbons and water. Bulk water is removed from the lead stripper overhead stream resulting in an unstabilized hydrocarbon stream, which is passed to a stabilization column to separate a stabilized naphtha-containing stream from the lower boiling point range hydrocarbons. The stabilized naphtha-containing stream is passed to a rectification column to separate a rectification bottoms stream and a naphtha product stream. Kerosene and diesel boiling range product streams are separated from the lead stripper bottoms stream in a vacuum fractionator.

### FIELD OF THE INVENTION

The present invention relates to the field of producing kerosene and diesel from renewable sources and, in particular, to a process for improving the yield of kerosene and/or diesel from renewable sources.

### BACKGROUND OF THE INVENTION

The increased demand for energy resulting from worldwide economic growth and development has contributed to an increase in concentration of greenhouse gases in the atmosphere. This has been regarded as one of the most important challenges facing mankind in the 21st century. To mitigate the effects of greenhouse gases, efforts have been made to reduce the global carbon footprint. The capacity of the earth's system to absorb greenhouse gas emissions is already exhausted. Accordingly, there is a target to reach net-zero emissions by 2050. To realize these reductions, the world is transitioning away from solely conventional carbon-based fossil fuel energy carriers. A timely implementation of the energy transition requires multiple approaches in parallel, including, for example, energy conservation, improvements in energy efficiency, electrification, and efforts to use renewable resources for the production of fuels and fuel components and/or chemical feedstocks.

Vegetable oils, oils obtained from algae, and animal fats are seen as renewable resources. Also, deconstructed materials, such as pyrolyzed recyclable materials or wood, are seen as potential resources.

Renewable materials may comprise materials such as triglycerides with very high molecular mass and high viscosity, which means that using them directly or as a mixture in fuel bases is problematic for modern engines. On the other hand, the hydrocarbon chains that constitute, for example, triglycerides are essentially linear and their length (in terms of number of carbon atoms) is compatible with the hydrocarbons used in/as fuels. Thus, it is attractive to transform triglyceride-comprising feeds in order to obtain good quality fuel components.

Petroleum-derived jet fuels inherently contain both paraffinic and aromatic hydrocarbons. In general, paraffinic hydrocarbons offer the most desirable combustion cleanliness characteristics for jet fuels. Challenges in using paraffinic hydrocarbons from renewable sources include higher boiling point, due to chain length, and higher freeze point. Solutions to these challenges include cracking to reduce chain length and/or isomerization to increase branching to reduce the freeze-point. Aromatics generally have the least desirable combustion characteristics for aircraft turbine fuel. In aircraft turbines, certain aromatics, such as naphthalenes, tend to burn with a smokier flame and release a greater proportion of their chemical energy as undesirable thermal radiation than other more saturated hydrocarbons.

Brady et al. (U.S. Pat. No. 8,193,400, 5 Jun. 2012) relates to a process for producing a branched-paraffin-enriched diesel product by hydrogenating/hydrodeoxygenating a renewable feedstock, separating a gaseous stream comprising H₂, H₂O and carbon oxides from n-paraffins in a hot high-pressure hydrogen stripper, and isomerizing the n-paraffins to generate a branched paraffin-enriched stream. The paraffin-enriched stream is cooled and separated into (i) an LPG and naphtha stream and (ii) a diesel boiling range stream. A portion of stream (i), (ii) or separated LPG and/or naphtha from stream (i) is recycled to the rectification zone of the hot high-pressure stripper to increase the hydrogen solubility of the reaction mixture. The effluent from the hot high-pressure stripper is then isomerized.

Similarly, Brady et al. (U.S. Pat. No. 8,198,492, 12 Jun. 2012) relates to a process for producing diesel and aviation boiling point products by hydrogenating/hydrodeoxygenating a renewable feedstock and separating a gaseous stream comprising H₂, H₂O and carbon oxides from n-paraffins in a hot high-pressure hydrogen stripper. The n-paraffins are isomerized and selectively cracked to generate a branched paraffin-enriched stream. The paraffin-enriched stream is cooled and separated into an overhead stream, a diesel boiling point range product and an aviation boiling point range product. A portion of the diesel boiling point range product, the aviation boiling point range product, naphtha product, and/or LPG is recycled to the rectification zone of the hot high-pressure stripper to decrease the amount of product carried in the stripper overhead. The effluent from the hot high-pressure stripper is then isomerized.

In Marker et al. (U.S. Pat. No. 8,314,274, 20 Nov. 2012), a renewable feedstock is hydrogenated/hydrodeoxygenated and then isomerized and selectively hydrocracked to generate an effluent comprising branched paraffins. The effluent is separated to provide an overhead stream, an optional aviation product stream, a diesel stream and a stream having higher boiling points. A portion of the diesel boiling point range product is recycled to the isomerization and selective hydrocracking zone.

Stewart et al. (U.S. Pat. No. 8,999,152, 7 Apr. 2015) address a challenge of maximizing diesel production from petroleum-derived feed while preserving kerosene yield. A hydroprocessed effluent stream is stripped and the stripped effluent is separated into a heavy naphtha stream, a kerosene stream and a diesel stream. The heavy naphtha stream is blended with the diesel stream to yield a blended diesel stream.

Ladkat et al. (U.S. Pat. No. 9,234,142, 12 Jan. 2016 and U.S. Pat. No. 10,041,008, 7 Aug. 2018) describe an apparatus for hydroprocessing petroleum-derived feed. Cold hydroprocessed effluent is passed to a cold stripping column and a light fractionation column, while a hot hydroprocessed effluent is passed to a hot stripping column and a heavy fractionation column.

There remains a need for improving the yield of kerosene from renewable sources.

### SUMMARY OF THE INVENTION

According to one aspect of the present invention, there is provided a process for improving yield of kerosene from a renewable feedstock, the process comprising the steps of: reacting a renewable feedstock in a hydroprocessing section under hydroprocessing conditions sufficient to cause a hydroprocessing reaction to produce a hydroprocessed effluent; separating the hydroprocessed effluent to produce at least one hydroprocessed liquid stream and at least one offgas stream; directing the at least one hydroprocessed liquid stream to a lead stripper to separate a lead stripper bottoms stream and a lead stripper overhead stream comprising naphtha, lower boiling point range hydrocarbons, higher boiling point range hydrocarbons, and water; condensing the lead stripper overhead stream and removing bulk water from the lead stripper overhead stream resulting in an unstabilized hydrocarbon stream; passing the unstabilized hydrocarbon stream to a stabilization column to separate a stabilized naphtha-containing stream from the lower boiling point range hydrocarbons; passing the stabilized naphtha-containing stream to a rectification column to separate a rectification bottoms stream and a naphtha product stream; and passing the lead stripper bottoms stream to a vacuum fractionator to produce an overhead stream, a kerosene boiling point range product stream and a diesel boiling point range product stream

### BRIEF DESCRIPTION OF THE DRAWINGS

The process of the present invention will be better understood by referring to the following detailed description of preferred embodiments and the drawings referenced therein, in which:

FIG. 1 is a schematic illustrating a general overview of one embodiment of the process of the present invention;

FIG. 2 illustrates an embodiment of a work-up section for use in the process of the present invention; and

FIG. 3 illustrates an embodiment of a vacuum fractionator zone for use in the process of the present invention.

### DETAILED DESCRIPTION OF THE INVENTION

The present invention provides a process for improving the yield of kerosene and/or diesel in the hydroprocessing of material from renewable sources.

The process of the present invention is important for the energy transition and can improve the environment by producing low carbon energy and/or chemicals from renewable sources, and, in particular, from degradable waste sources, whilst improving the efficiency of the process.

A common challenge for processing renewable feedstocks to produce kerosene and/or diesel is the variability of renewable feedstocks. Variability of renewable feedstocks may include a change from one type of feedstock to another, for example, due to supply and/or markets, changes in feedstock quality and/or composition profile, seasonal variations, variations between sources of same feedstock, and the like. Reaction schemes, operating conditions, heat generation, process efficiency, product composition, and/or product yield may each be impacted by such variability. A further challenge for meeting product specifications is that the product component yields change as catalyst activity changes, and/or from start-of-run to end-of-run. The process of the present invention provides flexibility and robustness to allow for feedstock variability, changes in catalyst activity, and/or changes in desired products, while reducing energy consumption, operating costs, and/or carbon footprint. Further, the process of the present invention enables revamp of existing process schemes used for processing petroleum-derived feedstock.

In the process of the present invention, a renewable feedstock is reacted in a hydroprocessing section to produce a hydroprocessed effluent. The hydroprocessed effluent is separated to produce at least one hydroprocessed liquid stream and at least one offgas stream. The one or more hydrocarbon liquid streams are directed to a work-up section.

In accordance with the work-up section of the present invention, the one or more hydroprocessed liquid streams are directed to a lead stripper. A lead stripper bottoms stream is separated from a lead stripper overhead stream comprising naphtha, lower and higher boiling point range hydrocarbons and water. The lead stripper overhead stream is condensed and bulk water is removed from the lead stripper overhead hydrocarbon stream, which is stabilized in a stabilization column where H₂S, lower boiling point range hydrocarbons and water are removed. The stabilized naphtha-containing stream is sent to a rectification column to separate a rectification bottoms stream and a naphtha product stream. The stripper bottoms stream from the lead stripper is substantially free of naphtha and an aqueous phase. The stripper bottoms stream from the lead stripper is passed to a vacuum fractionator for separating an overhead stream, a kerosene boiling point range product stream, and a diesel boiling point range product stream.

The present inventors have discovered that, by removing bulk water and the naphtha boiling range product from the higher boiling point range hydrocarbons, a vacuum can be efficiently pulled in the vacuum fractionator, resulting in much lower operating temperatures, and higher kerosene recovery with lower energy usage. As will be discussed in more detail below, the lower operating temperatures in the vacuum fractionator enable energy savings and a lower carbon footprint. Furthermore, the separate naphtha handling section enables a more consistent yield of higher value products, such as kerosene and/or diesel.

Embodiments of process units for carrying out the method of the present invention are described below and/or illustrated in the drawings. For ease of discussion, additional equipment and process steps that may be used in a process for producing kerosene and/or diesel from a renewable feedstock are not shown. The additional equipment and/or process steps may include, for example, without limitation, pre-treaters, heaters, chillers, air coolers, heat exchangers, mixing chambers, valves, pumps, compressors, condensers, quench streams, recycle streams, slip streams, purge streams, reflux streams, and the like.

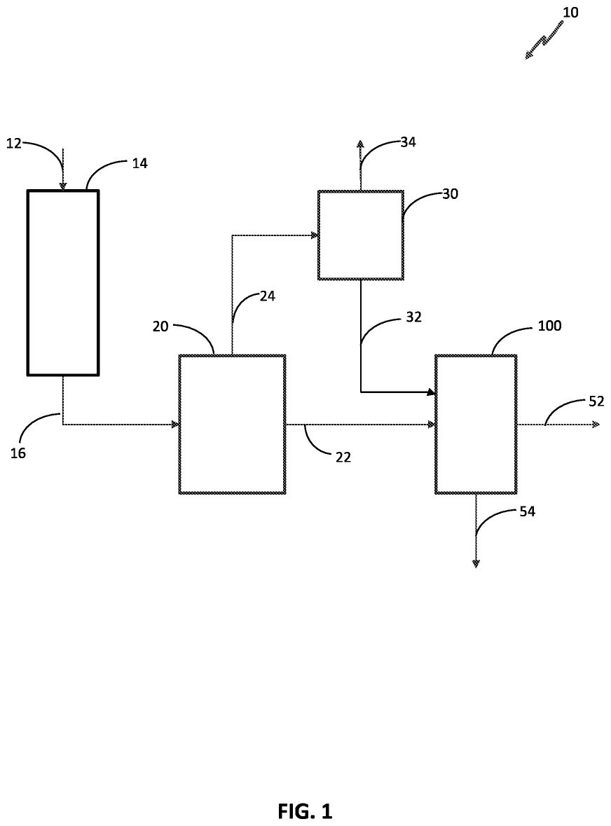

FIG. 1 illustrates a general overview of one embodiment of the process of the present invention 10. A renewable feedstock 12 is reacted in a hydroprocessing section 14 to produce a hydroprocessed effluent 16. Hydrogen may be combined with the renewable feedstock 12 stream before it is introduced the hydroprocessing section 14, co-fed with the renewable feedstock 12, or added to the hydroprocessing section 14 independently of the renewable feedstock 12. Hydrogen may be fresh and/or recycled from another unit in the process and/or produced in a HMU (not shown). In another embodiment, the hydrogen may be produced in-situ in the reactor or process, for example, without limitation, by water electrolysis. The water electrolysis process may be powered by renewable energy (such as solar photovoltaic, wind or hydroelectric power) to generate green hydrogen, nuclear energy or by non-renewable power from other sources (grey hydrogen).

As used herein, the terms “renewable feedstock”, “renewable feed”, and “material from renewable sources” mean a feedstock from a renewable source. A renewable source may be animal, vegetable, microbial, and/or bio-derived or mineral-derived waste materials suitable for the production of fuels, fuel components and/or chemical feedstocks.

A preferred class of renewable materials are bio-renewable fats and oils comprising triglycerides, diglycerides, monoglycerides, free fatty acids, and/or fatty acid esters derived from bio-renewable fats and oils. Examples of fatty acid esters include, but are not limited to, fatty acid methyl esters and fatty acid ethyl esters. The bio-renewable fats and oils include both edible and non-edible fats and oils. Examples of bio-renewable fats and oils include, without limitation, algal oil, brown grease, canola oil, carinata oil, castor oil, coconut oil, colza oil, corn oil, cottonseed oil, fish oil, hempseed oil, jatropha oil, lard, linseed oil, milk fats, mustard oil, olive oil, palm oil, peanut oil, rapeseed oil, pongamia oil, sewage sludge, soy oils, soybean oil, sunflower oil, tall oil, tallow, used cooking oil, yellow grease, white grease, and combinations thereof.

Another preferred class of renewable materials are liquids derived from biomass and waste liquefaction processes. Examples of such liquefaction processes include, but are not limited to, (hydro)pyrolysis, hydrothermal liquefaction, plastics liquefaction, and combinations thereof. Renewable materials derived from biomass and waste liquefaction processes may be used alone or in combination with bio-renewable fats and oils.

The renewable materials to be used as feedstock in the process of the present invention may contain impurities. Examples of such impurities include, but are not limited to, solids, iron, chloride, phosphorus, alkali metals, alkaline-earth metals, polyethylene and unsaponifiable compounds. If required, these impurities can be removed from the renewable feedstock before being introduced to the process of the present invention. Methods to remove these impurities are known to the person skilled in the art.

The process of the present invention is most particularly advantageous in the processing of feed streams comprising substantially 100% renewable feedstocks. However, in one embodiment of the present invention, renewable feedstock may be co-processed with petroleum-derived hydrocarbons. Petroleum-derived hydrocarbons include, without limitation, all fractions from petroleum crude oil, natural gas condensate, tar sands, shale oil, synthetic crude, and combinations thereof. The present invention is more particularly advantageous for a combined renewable and petroleum-derived feedstock comprising a renewable feed content in a range of from 30 to 99 wt. %.

In the hydroprocessing section 14, renewable feedstock 12 is reacted under hydroprocessing conditions sufficient to cause a reaction selected from hydrogenation, hydrotreating (including, without limitation, hydrodeoxygenation, hydrodenitrogenation, hydrodesulphurization, and hydrodemetallization), hydrocracking, selective cracking, hydroisomerization, and combinations thereof. The reactions are preferably catalytic reactions, but may include non-catalytic reactions, such as thermal processing and the like. The hydroprocessing section 14 may be a single-stage or multi-stage. The hydroprocessing section 14 may be comprised of a single reactor or multiple reactors. In the case of catalytic reactions, the hydroprocessing section 14 may be operated in a slurry, fluidized bed, and/or fixed bed operation. In the case of a fixed bed operation, each reactor may have a single catalyst bed or multiple catalyst beds. The hydroprocessing section 14 may be operated in a co-current flow, counter-current flow, or a combination thereof.

An example of a single-stage reaction is disclosed in van Heuzen et al. (U.S. Pat. No. 8,912,374, 16 Dec. 2014), wherein hydrogen and a renewable feedstock are reacted with a hydrogenation catalyst under hydrodeoxygenation conditions. The whole effluent from the hydrodeoxygenation reaction is contacted with a catalyst under hydroisomerization conditions. The single-stage reaction may be carried out in a single reactor vessel or in two or more reactor vessels. The process may be carried out in a single catalyst bed, for example, using a multi-functional catalyst. Alternatively, the process may be carried out in a stacked bed configuration, where a first catalyst composition is stacked on top of a second catalyst composition.

The catalyst may be the same, a mixture or different throughout the hydroprocessing section 14. The hydroprocessing section 14 may comprise a single catalyst bed or multiple catalyst beds. The catalyst may be the same throughout the single catalyst bed, optionally there is a mixture of catalysts, or different catalysts may be provided in two or more layers in the catalyst bed. In an embodiment of multiple catalyst beds, the catalyst may be same or different for each catalyst bed.

The hydrogenation components may be used in bulk metal form or the metals may be supported on a carrier. Suitable carriers include refractory oxides, molecular sieves, and combinations thereof. Examples of suitable refractory oxides include, without limitation, alumina, amorphous silica-alumina, titania, silica, and combinations thereof. Examples of suitable molecular sieves include, without limitation, zeolite Y, zeolite beta, ZSM-5, ZSM-12, ZSM-22, ZSM-23, ZSM-48, SAPO-11, SAPO-41, ferrierite, and combinations thereof.

The hydroprocessing catalyst may be any catalyst known in the art that is suitable for hydroprocessing. Catalyst metals are often in an oxide state when charged to a reactor and preferably activated by reducing or sulphiding the metal oxide. Preferably, the hydroprocessing catalyst comprises catalytically active metals of Group VIII and/or Group VIB, including, without limitation, Pd, Pt, Ni, Co, Mo, W, and combinations thereof. Hydroprocessing catalysts are generally more active in a sulphided form as compared to an oxide form of the catalyst. A sulphiding procedure is used to transform the catalyst from a calcined oxide state to an active sulphided state. Catalyst may be pre-sulphided or sulphided in situ. Because renewable feedstocks generally have a low sulphur content, a sulphiding agent is often added to the feed to maintain the catalyst in a sulphided form.

Preferably, the hydrotreating catalyst comprises sulphided catalytically active metals. Examples of suitable catalytically active metals include, without limitation, sulphided nickel, sulphided cobalt, sulphided molybdenum, sulphided tungsten, sulphided CoMo, sulphided NiMo, sulphided MoW, sulphided NiW, and combinations thereof. A catalyst bed/zone may have a mixture of two types of catalysts and/or successive beds/zones, including stacked beds, and may have the same or different catalysts and/or catalyst mixtures. In case of such sulphided hydrotreating catalyst, a sulphur source will typically be supplied to the catalyst to keep the catalyst in sulphided form during the hydroprocessing step.

The hydrotreating catalyst may be sulphided in-situ or ex-situ. In-situ sulphiding may be achieved by supplying a sulphur source, usually H₂S or an H₂S precursor (i.e. a compound that easily decomposes into H₂S such as, for example, dimethyl disulphide, di-tert-nonyl polysulphide or di-tert-butyl polysulphide) to the hydroprocessing catalyst during operation of the process. The sulphur source may be supplied with the feed, the hydrogen stream, or separately. An alternative suitable sulphur source is a sulphur-comprising hydrocarbon stream boiling in the diesel or kerosene boiling range that is co-fed with the feedstock. In addition, added sulphur compounds in feed facilitate the control of catalyst stability and may reduce hydrogen consumption.

Preferably, the hydroprocessing reactions include a hydroisomerization reaction to increase branching, thereby reducing the freezing point of the fuel.

The hydroprocessing section 14 may be operated as a single-stage process or a multi-stage process. In one preferred embodiment, the hydroprocessing section 14 is operated as a single-stage process, in a co-current mode with one or more fixed beds. In one embodiment, the hydroprocessing section 14 has a single hydroprocessing reactor having one or more catalyst beds having the same multi-functional catalyst composition for catalysing at least one hydrotreating reaction, preferably hydrodeoxygenation, and a hydroisomerization reaction. In another embodiment, the hydroprocessing section 14 has a single hydroprocessing reactor with a first catalyst composition, having a hydrotreating function, stacked on top of a second catalyst composition, having an isomerization function. In another embodiment, the hydroprocessing section 14 has two or more hydroprocessing reactors, for at least two catalyst compositions. In yet another embodiment, the isomerization catalyst may also include a selective cracking function. Alternatively, a selective cracking catalyst may be provided in the same or different bed. Different numbers of catalyst beds may be used in each hydroprocessing reactor.

The hydroprocessed effluent 16 is then directed to a separation system 20 and a work-up section 100, for separating an overhead stream, a kerosene boiling point range product stream 52, and a diesel boiling point range product stream 54.

In another preferred embodiment, the hydroprocessing section 14 is operated as a multi-stage process, in a co-current mode with one or more fixed beds.

In one embodiment, the hydroprocessing section 14 has two hydroprocessing reactors. In another embodiment, the hydroprocessing section 14 has three hydroprocessing reactors, where the first and second reactors operate as a single-stage, and the second and a third reactors operate in a multi-stage configuration with an intervening separation system 20. Alternatively, the first and second reactors may operate in a multi-stage configuration with an intervening separation system, which may share some or all of the separator units of the separation system 20 between the second and third reactors.

The hydroprocessing reactors may each independently have one or more catalyst beds. The type of catalyst used in each hydroprocessing reactor may be the same or different. In a preferred embodiment, a first catalyst is a hydrotreating catalyst and a second catalyst is a hydroisomerization catalyst. In a preferred embodiment, a separation system 20 is provided between the hydrotreating and hydroisomerization zones/reactors. Hydroprocessed effluent from the hydrotreating zone/reactor is separated to produce one or more hydroprocessed liquid stream 32 and one or more separation system offgas stream 34. All or a portion of the hydroprocessed liquid stream 32 is directed to hydroisomerization reactor/zone.

A portion of the hydroprocessed effluent 16 and the hydroprocessed liquid stream 32 from one or more separator units may be returned to a first hydroprocessing reactor, for example, as a quench stream (not shown) or as a diluent (not shown) of feedstock 12. The hydroprocessed effluent from a second and/or third hydroprocessing reactor/zone may be directed to one or more separation units of separation system 30 or to a different separator before being directed to the work-up section 100.

The hydroprocessed effluent 16 is directed to a separation system 20 to produce at least one hydroprocessed liquid stream 22 and at least one separation system offgas stream 24.

The separation system 20 has one or more separation units including, for example, without limitation, gas/liquid separators, including hot high- and low-pressure separators, intermediate high- and low-pressure separators, cold high- and low-pressure separators, strippers, integrated strippers and combinations thereof. Integrated strippers include strippers that are integrated with hot high- and low-pressure separators, intermediate high- and low-pressure separators, cold high- and low-pressure separators. It will be understood by those skilled in the art that high-pressure separators operate at a pressure that is close to the hydroprocessing section 14 pressure, suitably 0-10 bar (0-1 MPa) below the reactor outlet pressure, while a low-pressure separator is operated at a pressure that is lower than a preceding reactor in the hydroprocessing section 14 pressure or a preceding high-pressure separator, suitably 0-15 barg (0-1.5 MPaG). Similarly, it will be understood by those skilled in the art that hot means that the hot-separator is operated at a temperature that is close to a preceding reactor in the hydroprocessing section 14 temperature, suitably sufficiently above water dew point (e.g., ≥20° C., preferably ≥10° C., above the water dew point) and sufficiently greater than salt deposition temperatures (e.g., ≥20° C., preferably ≥10° C., above the salt deposition temperature), while intermediate- and cold-separators are at a reduced temperature relative to the preceding reactor in the hydroprocessing section 14. For example, a cold-separator is suitably at a temperature that can be achieved via an air cooler. An intermediate temperature will be understood to mean any temperature between the temperature of a hot- or cold-separator.

In addition, the separation system 20 may include one or more treating units including, for example, without limitation, a membrane separation unit, an amine scrubber, a pressure swing adsorption (PSA) unit, a caustic wash, and combinations thereof. The treating units are preferably selected to separate desired gas phase molecules. For example, an amine scrubber is used to selectively separate H₂S and/or carbon oxides from H₂ and/or hydrocarbons. As another example, a PSA unit may be used to purify a hydrogen stream for recycling to a stripper and/or a reactor in the hydroprocessing section 14.

Hydroprocessed effluent from one or more reactor in the hydroprocessing section 14 may each be treated in a separate embodiment of the separation system 20. Effluents from different reactors/zones may be treated in all or some of the same separation units.

In one embodiment, the separation system 20 includes a hot separator (HS), such as a hot high-pressure separator, a hot low-pressure separator, and/or an integrated stripper separator, and a cold separator (CS), such as a cold high-pressure separator and/or a cold low-pressure separator. The HS flashes off hydrogen-rich gases, in addition to light hydrocarbons, CO₂, carbon monoxide and H₂S, from hydroprocessed effluents, resulting in a hydroprocessed liquid stream 22 and/or an interstage liquid stream. An interstage liquid stream is directed in whole or in part to a subsequent hydroprocessing zone and/or reactor. All or a portion of the hydroprocessed liquid stream 22 is directed to the work-up section 100. The HS offgas is then cooled, for example in an air cooler (not shown) or a heat exchanger (not shown), and directed to the CS, where at least a portion of the light hydrocarbons are separated from the HS offgas stream as a liquid effluent stream, preferably combined with the effluent from another hydroprocessing zone/reactor and/or the hydroprocessed liquid stream 22. The offgas stream 24 may be directed to the gas-handling section 30, to a gas treating unit, or used for another purpose.

A portion of the liquid effluent from the HS and/or the CS may be recycled and/or used as a diluent and/or a quench stream between catalyst beds in one or more reactor in the hydroprocessing section 14. For example, by recycling from the HS, the operating costs from pumping and/or heating can be reduced.

In another embodiment, the separation system 20 includes a HS, a CS, and a PSA unit. All or a portion of the offgas stream from the CS is directed to the PSA unit to separate a hydrogen-enriched stream from the CS offgas stream. The hydrogen-enriched stream may be recycled to one or more reactors in the hydroprocessing section 14, a stripper in the separation system 20 or work-up section 100, and/or another processing unit in the refinery. The hydrogen-enriched stream may be compressed in compressor prior to recycle. The offgas stream 24 may also include a portion of the offgas from the HS and/or CS. The offgas stream 24 may be directed to the gas-handling section 30 to another gas treating unit, not shown, or used for another purpose.

In yet another embodiment, the separation system 20 includes a HS, a CS, and an amine scrubber. The offgas stream from the CS is directed to the amine scrubber to separate a hydrogen-enriched stream from the CS offgas stream.

Optionally, all or a portion of the offgas stream from the CS is first directed to a PSA and the tail gas therefrom is then directed to the amine scrubber. In this embodiment, the tail gas from the PSA is typically at a lower pressure than the pressure of the amine scrubber. Accordingly, it may be desirable to compress the PSA tail gas prior to directing the tail gas to the amine scrubber. Alternatively, the PSA tail gas may be directed as an offgas stream 24 for handling in the gas-handling section 30 before being directed to the amine scrubber.

The hydrogen-enriched stream from the amine scrubber and/or the PSA unit may be recycled to one or more reactors in the hydroprocessing section 14, a stripper in the separation system 20 or work-up section 100, and/or another processing unit. The hydrogen-enriched stream may be compressed in compressor prior to recycle.

The amine scrubber may be a scrubber containing monoethanolamine (MEA), diethanolamine (DEA), methyldiethanolamine (MDEA), promoted MEA, DEA, and/or MDEA, activated MEA, DEA and/or MDEA, and combinations thereof for removal of carbon monoxide. The offgas stream 24 may also include a portion of the offgas from the HS and/or CS. Preferably, the amine-rich stream from the amine scrubber is regenerated in a low-pressure amine regenerator and the off-gas from the amine generator overhead may be directed to the gas-handling section 30. The offgas stream 24 may be directed to the gas-handling section 30, to another gas treating unit, or used for another purpose.

It will be understood by those skilled in the art that the same or different separation units and/or the treating units may be provided between and/or after catalyst zones in the hydroprocessing section 14 and between and/or after components of the gas-handling section 30 and/or the work-up section 100.

The separation system offgas stream 24 is directed to the gas-handling section 30. Gas streams in the gas-handling section 30 are preferably subjected to pressurizing and/or cooling operations to obtain a pressurized gas stream 34 and a hydrocarbon fraction 32. Examples of suitable equipment for the gas-handling section 30 include, without limitation, compressors, heat exchangers, ejectors, knock-out drums, driers, turbines, and combinations thereof.

The hydrocarbon fraction 32 from the gas-handling section 30 may be passed to the work-up section 100 or another stream or unit in the process.

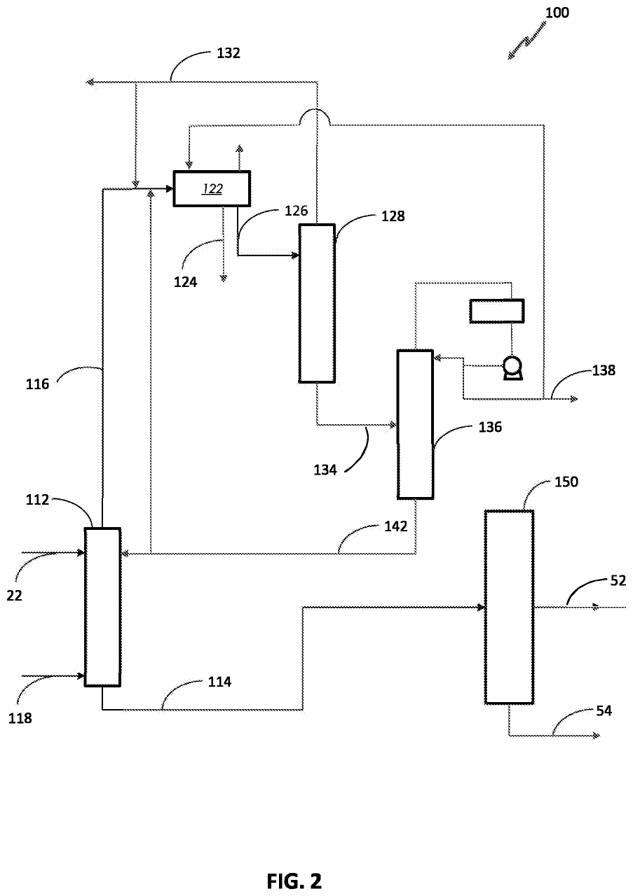

One or more hydroprocessed liquid stream 22 is directed to a work-up section 100. Referring now to FIG. 2, one or more hydroprocessed liquid stream 22 is directed to a lead stripper 112, where a lead stripper overhead stream 116 is separated from a lead stripper bottoms stream 114, using a stripper gas 118. Stripper gases include, without limitation, steam, hydrogen, methane, nitrogen, and the like. Some stripping gases may be less efficient than others and/or may require additional process equipment. Accordingly, a preferred stripper gas 118 is steam in view of its low molecular weight and relatively high condensing temperature.

In accordance with the present invention, naphtha from the hydroprocessed liquid stream 22 is stripped from the higher boiling point hydrocarbons and carried from the lead stripper 112 in the stripper overhead stream 116. In addition to naphtha, the stripper overhead stream includes lighter and heavier hydrocarbons, H₂S, and water, from the stripping gas 118 and/or any remaining water from the separation system 20.

The lead stripper 112 is operated at a temperature and pressure to allow for separation of naphtha and water from the higher boiling point hydrocarbons. Preferably, the lead stripper 112 is operated in a temperature and pressure range to avoid water dew point in the lead stripper 112 and to provide optimal recovery of product naphtha, with the resulting temperature profile depending upon the pressure chosen for the particular design. In turn, the design pressure will depend, for example, on type of equipment, such as presence or absence of a compressor, and the like. As an example, the lead stripper 112 may be operated at a temperature in a range of from about 150° C. to 280° C., preferably in a range of from about 180° C. to 220° C. and a pressure in a range of from about 2 to 12 barg (0.2 to 1.2 MPaG), preferably from about 5 to 8 barg (0.5 to 0.8 MPaG). Preferably, the hydroprocessed liquid stream 22 is fed to the lead stripper 112 at a suitable temperature to allow the lead stripper 112 to operate at a temperature above water dew point. Moreover, a higher temperature in the lead stripper 112 reduces naphtha slip to the stripper bottoms stream 114, thereby improving operation of the vacuum fractionator, discussed in more detail below. A heat exchanger (not shown) may be provided to heat the hydroprocessed liquid stream 22 before being fed to the lead stripper 112.

Bulk water 124 condenses and is separated from the lead stripper overhead stream 116 in a condenser or accumulator 122 as a liquid stream. A small portion of the H₂S may dissolve in the condensed water. The resulting unstabilized hydrocarbon stream 126, containing light and heavy hydrocarbons, may still include saturated and/or entrained water that was not removed in the condenser or accumulator 122. The unstabilized hydrocarbon stream 12, is passed to a naphtha stabilization column 128 to remove a stabilizer overhead stream 132, containing H₂S, water, and light hydrocarbons. All or a portion of the stabilizer overhead stream 132 may be returned to the lead stripper overhead stream 116 upstream of the condenser or accumulator 122 to re-absorb the naphtha components from the stabilizer overhead.

The lead stripper 112, condenser or accumulator 122 and naphtha stabilization column 128 operate at a pressure, preferably by a common pressure controller, selected to keep the lead stripper 112 above the water dew point. The combined overhead avoids the need for a compressor or a dedicated overhead drum and pumps for the stabilization column 128 and uses the stripper overhead as sponge absorber for the naphtha components.

The stabilized naphtha-containing stream 134 is passed from the naphtha stabilization column 128 to a rectification column 136, where a naphtha product stream 138 is separated from a rectification bottoms stream 142 containing higher boiling point range hydrocarbons. The rectification bottoms stream 142 is recycled to the lead stripper 112.

By separating the naphtha boiling point range hydrocarbons in the overhead of the lead stripper 112, the naphtha product 138 is provided as a clean and stabilized product stream, free of water and H₂S, reducing any build-up of light naphtha components that can occur in an overhead stream of a typical lead stripper where naphtha is recovered in the bottoms stream. Furthermore, this allows for the use of medium pressure (MP) steam for the respective reboilers (not shown).

One of the advantages of the present invention is the flexibility for making on-the-fly changes to the process to meet product specifications for kerosene and/or diesel when there is variability in the renewable feedstock being processed. Variability of renewable feedstocks may include a change from one type of feedstock to another, for example, due to supply and/or markets, changes in feedstock quality and/or composition profile, seasonal variations, variations between sources of same feedstock, and the like. For example, hydroprocessing some feedstocks will result in lower levels of naphtha than other feedstocks. A common yield of naphtha is 10-15 wt. % based on feed. Depending on the feedstock, desired product (diesel versus kerosene), degree of catalyst deactivation, and/or whether the process is at a start-up phase, the amount of naphtha yield may be very low, for example 1 wt. %.

The process of the present invention 100 allows for recycle of the naphtha product stream 138 and/or the rectification bottoms stream 142. For example, a portion or all of the naphtha product stream 138 may be temporarily recycled to the condenser or accumulator 122. Further, a portion or all of the rectification bottoms stream 142 may be temporarily routed to the stripper overhead steam 116 upstream of the condenser or accumulator 122. A further advantage of the recycle streams enabled by the process of the present invention is to provide a handle for adjusting the log mean temperature difference (LMTD) on the reboilers (not shown) of the stabilization 128 and rectification 136 columns. For example, when there is very little naphtha, the temperature of the stabilization column 128 may be too high to enable use of MP steam for the reboiler. Recycling a portion or all of the naphtha product stream 138 may allow smaller reboiler sizes and/or ability to use lower quality heat mediums for the reboilers.

Preferably, the reboiler for the stabilization column 128 has a circulating thermosiphon reboiler configuration to further allow for a wide operating range. Preferably, the reboiler for the rectification column 136 has a forced circulation configuration to strengthen the robustness of the process over a wide operating envelope.

The lead stripper bottoms stream 114 is passed to the vacuum fractionator 150. In accordance with the present invention, the lead stripper bottoms stream 114 is substantially free of bulk water and naphtha boiling range and lower boiling hydrocarbons are substantially removed. This improves operation of the vacuum fractionator 150 by reducing energy consumption by the vacuum system. Moreover, because the bulk of the naphtha product is recovered in another unit, the vacuum fractionator 150 can be operated without the capital and operating expenses associated with a jet side-stripper, as required in conventional processes. Furthermore, by using a vacuum fractionator, the yield of kerosene product can be improved without the need for a furnace to heat the feed, for example, in a fired heater, and the associated operating and energy costs.

The vacuum fractionator 150 is preferably a packed column. Packing runs more efficiently under vacuum, as compared to atmospheric fractionation.

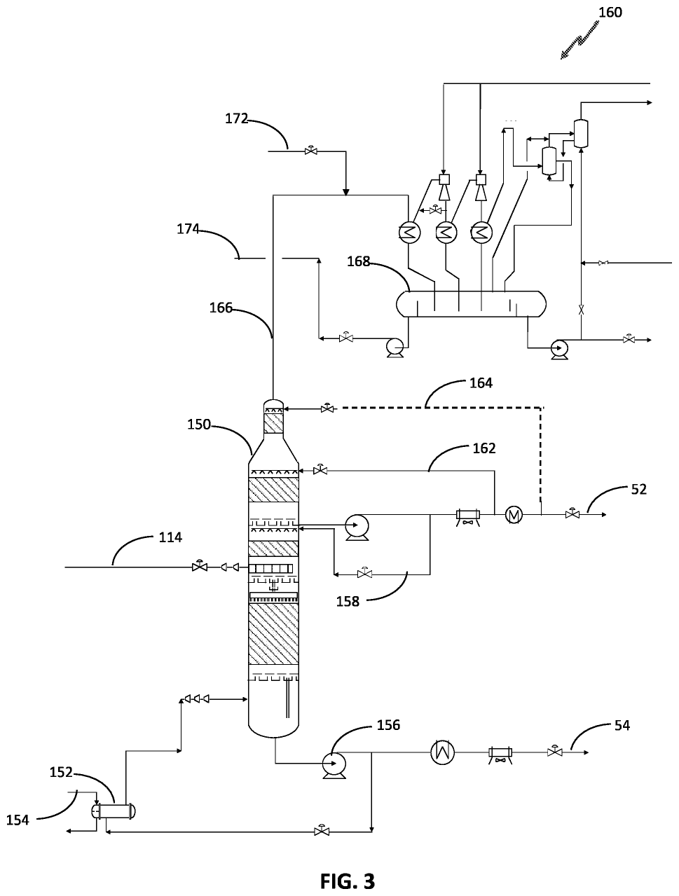

Turning now to FIG. 3, which illustrates an embodiment of a vacuum fractionator zone 160 for use in the process of the present invention 10, the lead stripper bottoms stream 114 is directed to the vacuum fractionator 150. The vacuum fractionator 150 may be operated under a range of vacuum pressures from mild to deep vacuum, depending on the composition of the lead stripper bottoms stream 114 and the desired product yields. For a given column diameter, the vacuum fractionator 150 of the present invention provides latitude for applied vacuum pressure. In this way, the vacuum pressure may be tailored to the available heat medium 154 in the reboiler 152. In the embodiment illustrated in FIG. 3, the reboiler is a forced circulation reboiler using pump 156 to circulate a portion of the diesel boiling point range product stream 54. The product stream 54 is vaporized by the heat medium 154 and returned to the vacuum fractionator 150 to drive fractionation. The heat medium 154 may be selected from steam, hot oil and/or hydroprocessing reactor effluent 22.

The lead stripper bottoms stream 114 is optionally preheated with a heat exchanger (not shown) to provide a handle for reducing the reboiler 152 duty requirement and also allows for reduction of the reboiler circulation rate. This flexibility in particularly advantageous in certain yield cases, for example, when the LMTD of the reboiler is relatively low.

A portion of the kerosene boiling point range product stream 52 is returned to the vacuum fractionator 150 through kerosene reflux stream 158, top circulating reflux stream 162, and, optionally, cold front reflux stream 164, to cool and/or condense vapors in the vacuum fractionation column 150. In a preferred embodiment, the cold front reflux stream 164 works with the top circulating reflux stream 162 to fine tune kerosene recovery adjustment.

In a preferred embodiment, an overhead stream 166 from the vacuum fractionator 150 is passed to an overhead condenser 168 with fuel gas 172. A heavy naphtha slop recycle stream 174 to the lead stripper overhead stream 116 is provided to address any naphtha slip in the feed to the vacuum fractionator 150.

The process of the present invention 10 allows for variability of renewable feedstocks, including a change from one type of feedstock to another, for example, due to supply and/or markets, changes in feedstock quality and/or composition profile, seasonal variations, variations between sources of same feedstock, and the like. The process of the present invention 10 provides flexibility to meet product specifications for diesel and/or kerosene despite resulting changes in reaction schemes, operating conditions, heat generation, process efficiency, product composition, and/or product yield that are impacted by such variability, even with changes in product component yields due to catalyst activity changes, and/or from start-of-run to end-of-run. The process of the present invention 10 provides flexibility and robustness to allow for feedstock variability, changes in catalyst activity, and/or changes in desired products, while reducing energy consumption, operating costs, and/or carbon footprint. Further, the process of the present invention enables revamp of existing process schemes used for processing petroleum-derived feedstock.

While the embodiments are described with reference to various implementations and exploitations, it will be understood that these embodiments are illustrative and that the scope of the inventive subject matter is not limited to them. Many variations, modifications, additions and improvements are possible. Various combinations of the techniques provided herein may be used.

1. A process for improving yield of kerosene from a renewable feedstock, the process comprising the steps of:
reacting a renewable feedstock in a hydroprocessing section under hydroprocessing conditions sufficient to cause a hydroprocessing reaction to produce a hydroprocessed effluent;
separating the hydroprocessed effluent to produce at least one hydroprocessed liquid stream and at least one offgas stream;
directing the at least one hydroprocessed liquid stream to a lead stripper to separate a lead stripper bottoms stream and a lead stripper overhead stream comprising naphtha, lower boiling point range hydrocarbons, higher boiling point range hydrocarbons, and water;
condensing the lead stripper overhead stream and removing bulk water resulting in an unstabilized hydrocarbon stream;
passing the unstabilized hydrocarbon stream to a stabilization column to separate a stabilized naphtha-containing stream from the lower boiling point range hydrocarbons;
passing the stabilized naphtha-containing stream to a rectification column to separate a rectification bottoms stream and a naphtha product stream; and
passing the lead stripper bottoms stream to a vacuum fractionator to produce an overhead stream, a kerosene boiling point range product stream and a diesel boiling point range product stream.

2. The process of claim 1, wherein a least a portion of the rectification bottoms stream is recycled to the lead stripper.

3. The process of claim 1, wherein at least a portion of the naphtha product stream is recycled to the step of removing water from the stripper overhead stream.

4. The process of claim 1, wherein at least a portion of the rectification bottom stream is recycled to the step of removing water from the stripper overhead column.

5. The process of claim 1, wherein the temperature of the hydroprocessed liquid stream is controlled to a temperature higher than the water dew point in the lead stripper.

6. The process of claim 1, wherein the lead stripper is operated at a pressure in a range of from 1 to 10 bar (0.1 to 1 MPa) above atmospheric pressure.

7. The process of claim 1, wherein the hydroprocessing reaction is selected from the group consisting of hydrogenation, hydrotreating, hydrocracking, hydroisomerization, selective cracking, and combinations thereof.

8. The process of claim 1, wherein the effluent-separating step comprises directing the effluent to one or more separator units, the separator unit selected from the group consisting of a hot high-pressure separator, a hot low-pressure separator, an intermediate high-pressure separator, an intermediate low-pressure separator, a cold high-pressure separator, a cold low-pressure separator, a stripper, an integrated stripper, and combinations thereof.

9. The process of claim 1, wherein the renewable feedstock is selected from the group consisting of one or more bio-renewable fats and oils, liquid derived from a biomass liquefaction process, liquid derived from a waste liquefaction process, and combinations thereof.

10. The process of claim 1, further comprising adding a petroleum-derived feedstock for co-processing with the renewable feedstock, preferably in an amount to produce a feed stream comprising from 30 to 99 wt. % renewable feedstock.
